(19) United States
(12) Patent Application Publication
(10) Pub. No.: US 2006/0129812 A1
(43) Pub. Date: Jun. 15, 2006

(54) Authentication for admitting parties into a network

(76) Inventor: Sachin Satish Mody, Lawrenceville, NJ (US)

Correspondence Address: THOMSON LICENSING INC., PATENT OPERATIONS, PO BOX 5312, PRINCETON, NJ, 08543-5312, US

(21) Appl. No.: 10/559,226

(22) PCT Filed: Jul. 7, 2003
(86) PCT No.: PCT/US03/21148

§ 371 Date: Dec. 6, 2005

(51) Int. Cl. H04L 9/00

(52) U.S. Cl. 713/168

(57) ABSTRACT

A system and device for authenticating and admitting parties located at remote sites (115) to a secure communication network (100), wherein each remote site includes a device operable to execute code for determining a first authenticating value received from a second site (110), which is blinded with a value associated with the remote site (115), encrypting and transmitting the determined value and decrypting a second authenticating value and validating the transmitting site (110) when the unblinded first authenticating value is equivalent to the second authenticating value. Furthermore, the transmitting site (110) includes a devices operable to execute code for generating and transmitting a first authenticating value blinded by a value associated with a remote site (115), decrypting a value and validating the remote site when the authenticating value is equivalent to the decrypted received value.

### FIELD OF THE INVENTION

This application is related to the field of secure networks and more specifically to apparatus for authenticating and admitting parties to a secure network configuration.

### BACKGROUND OF THE INVENTION

Since the introduction of the public network, such as the Internet, many businesses have changed their mode of operation considerably. Manufacturers and retailers, through the use of interactive dialogue pages, allow their consumers to buy products directly, using a conventional credit card. In this case, security of the credit card information is important to prevent theft of the credit card information and fraud. Conventionally, credit card information is transmitted over a secure socket layer (SSL) that encrypts the information using well-known encryption algorithms, such as RSA and digital certificates. As one skilled in the art would recognize, RSA refers to an encryption algorithm developed by Rivest, Shamir, and Adleman that generates public key and private key information based on the mathematics of large prime numbers. In operation, each party generates a public/private key combination pair and makes the public key available to all other parties. A first party may then encrypt information items using another party's public key and another party may decrypt the information item using the corresponding private key. Similarly, a party may digitally sign a document by encrypting information items using their private key and only another party having access to the corresponding public key is able decrypt the encrypted information. Thus, using public/private encryption algorithms, information items can be securely transmitted over networks while providing a level of assurance that the parties are authorized to transmit or receive the information items.

Video conferencing is an example wherein secure communications among the parties is particularly important. In this case, each party may “sign-on” to the video conference using either a provided public key or by using their private key. The conference may then proceed as each party is able to participate in the conference. However, encryption codes may be compromised, cracked or hacked and the authentication of the parties network may be suspect and the information transmitted over the network could become available to parties that are not authorized to receive such information. The release of this information may cause significant social and/or economic damage.

Accordingly, there is a need for a system and devices that ensures the authentication of the parties and further allows the admission of the authenticated parties to the secure network.

### SUMMARY OF THE INVENTION

A system and device for authenticating and admitting parties located at remote sites to a secure communication network, wherein each remote site includes a device operable to execute code for determining a first authenticating value received from a second site, which is blinded with a value associated with the remote site, encrypting and transmitting the determined value and decrypting a second authenticating value and validating the transmitting site when the unblinded first authenticating value is equivalent to the second authenticating value. Furthermore, the transmitting site includes a devices operable to execute code for generating and transmitting a first authenticating value blinded by a value associated with a remote site, decrypting a value and validating the remote site when the authenticating value is equivalent to the decrypted received value.

### BRIEF DESCRIPTION OF THE DRAWINGS

FIG. 1 illustrates a block diagram of a system utilizing the principles of the invention for authenticating parties to a transaction;

FIG. 2 illustrates a flow chart of a first process for authenticating parties in accordance with the principles of the invention;

FIG. 3 illustrates a flow chart of a second process for authenticating parties to a transaction in accordance with the principles of the invention;

FIG. 4 illustrates a flow chart of a process for admitting parties to a transaction in accordance with the principles of the invention;

FIG. 5 illustrates a flow chart of a second process for admitting parties to a transaction in accordance with the principles of the invention;

FIG. 6 illustrates the interactive communication between server and site for authenticating and establishing a link between parties in accordance with the principles of the invention; and

FIG. 7 illustrates a device for executing the processing shown in FIGS. 2 through 6.

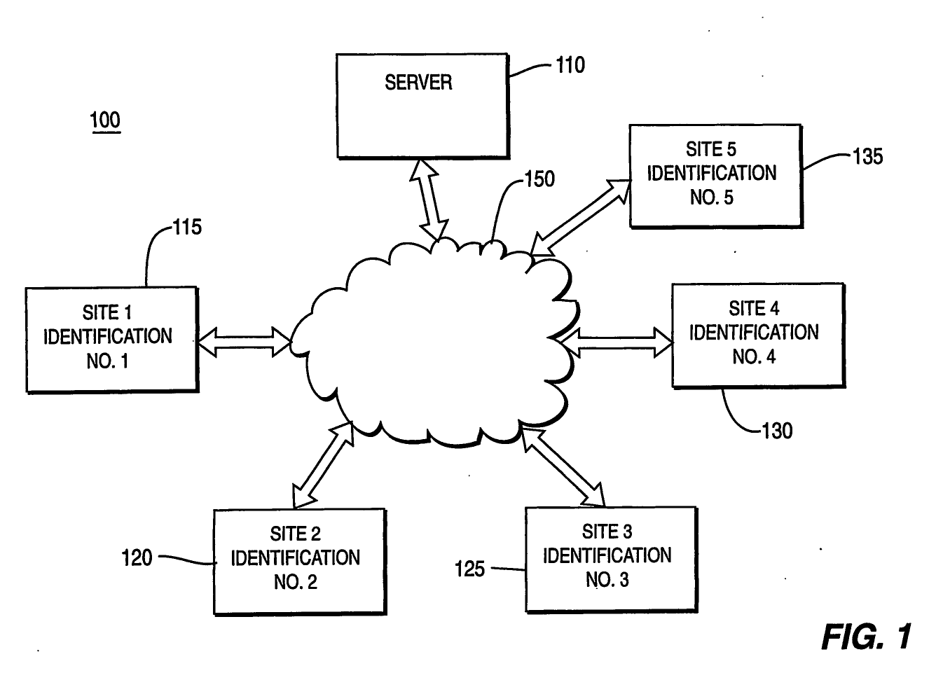

It is to be understood that these drawings are solely for purposes of illustrating the concepts of the invention and are not intended as a definition of the limits of the invention. The embodiments shown in FIGS. 1-7 and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION OF THE INVENTION

FIG. 1 illustrates a block diagram of a system 100 for requiring a secure communication link among a plurality of available remote sites over a network in accordance with the principles of the invention. In this illustrated diagram, server 110 is in communication, via network 150, to remote sites 115, 120, 125, 130 and 135. Protocols, e.g., TCP/IP, that provide for two-way communications over network 150 are well-known in the art and need not be discussed in detail herein.

Server 110 further includes information, such as a value, code or label, that uniquely identifies each remote site. That is, each remote site is registered with server 110. For example, site 115 may be identified, associated or registered with a unique value, code or label, which in this case is depicted as “Identification No. 1.” Further, site 120 may be identified, associated or registered with a value, code or label unique to site 120. In this case, site 120 is depicted as being uniquely identified by the label “Identification No. 2.” Similarly, site 135 may be identified, associated or registered with a unique value, code or label, which is depicted as “Identification No. 5.” Similar identifications are made for remote sites 125 and 130.

In one aspect of the invention, each associated identification value, code or label may be an arbitrarily selected value or combination of alpha-numeric values. In another aspect of the invention, each associated identification value, code or label may be selected to include known properties, e.g., a prime number of a known order or size.

Server 110 may generate and maintain each unique value associated with each remote site and provide this information to the associated remote site. In another aspect, server 110 may be provided each unique value by the corresponding remote site. In either aspect of the invention, knowledge of the unique remote site code is retained by server 110 and the associated remote site only. In addition, server 110 includes a public key/private key encryption algorithm, e.g., RSA. In one aspect, a common server public key may be distributed to each of the remote sites. In another aspect of the invention, server 110 may generate and associate a public key/private key for each remote site. In this aspect, the remote site is provided an individualized server public key. The public keys may be distributed to each of the remote sites on a periodic time basis, a random time basis, dynamically or upon request when a remote site registers with server 110 or when a conference among sites is scheduled. Preferably, public key(s) are provided when a request for a connection is received.

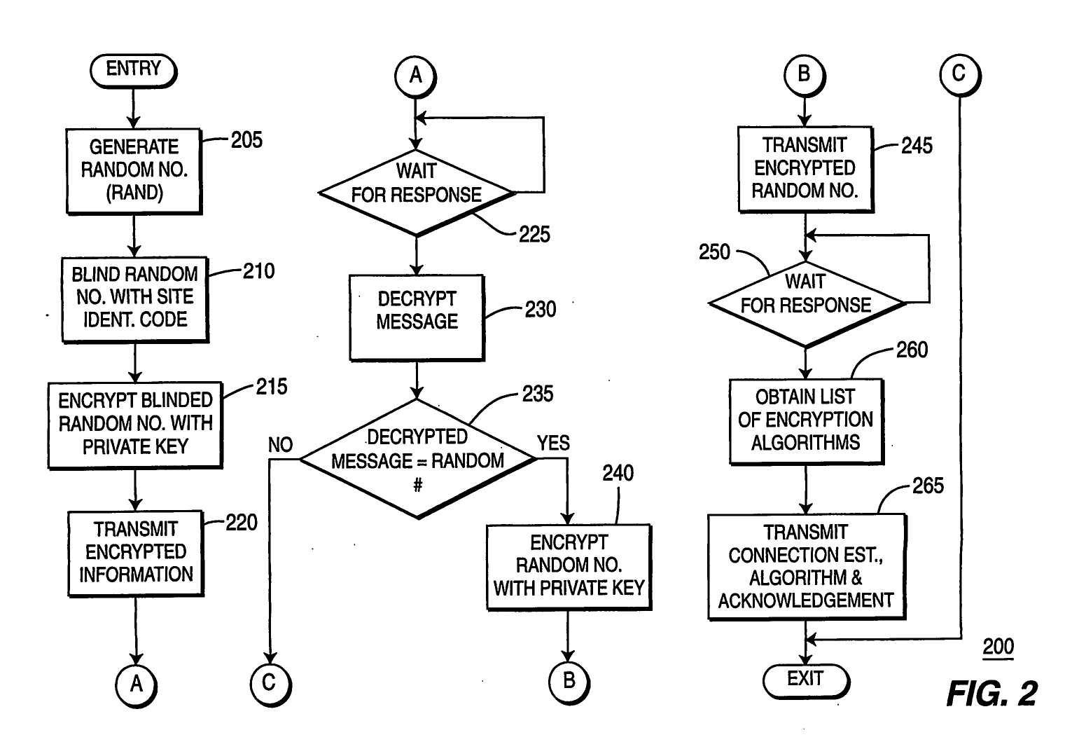

FIG. 2 illustrates a flow chart of an exemplary process 200 maintained on server 110 for authenticating parties to a secure transaction or communication in accordance with the principles of the invention. For the sake of clarity, the novel aspects of the invention are now described with regard to a conference invitor and a conference invitee. In this exemplary process 200, server 110, responsive to a request to establish a secure communication between invitor, e.g., remote site 120 from FIG. 1, and invitee, e.g., remote site 130, generates a random number for each party at block 205. At block 210, the generated random numbers are encrypted, warped or blinded using the unique identification value associated with the sites at block 210. In a preferred embodiment of the invention, the generated random numbers are blinded using the following relation:
R_exp1XOR IDₐ; and
R_exp2XOR ID_{b} [1]
where R_exp1 and R_exp2 are the two generated random numbers;
   IDₐ is the unique value associated with a first site;
   ID_{b} is the unique value associated with a second site; and
      XOR is a conventional Boolean Logical function.

At block 215, the two blinded values are then encrypted using the private key associated with server 110. That is, server 110 encrypt, or scramble, the blinded values. As would be understood by those skilled in the art, the process of encrypting a value obscures or scrambles the value in a manner that render the value unintelligible, unclear or in near of translation by those not in possession of a comparable decrypting process. At block 220, the encrypted blinded values are transmitted over network 150, shown in FIG. 1. At block 225, server 110 waits for a response from the remote sites. When a response is detected, the received message is decrypted using the private key of server 110 at block 230.

At block 235, a determination is made whether the decrypted received value is equal to the random value transmitted at block 220. If the answer is negative, then a response was received from a non-authorized site. Processing then exits, as the remote site cannot be authenticated.

However, if the answer is in the affirmative, then the identity of the remote site is confirmed, as only the specified remote site is able to return the generated and provided random number, i.e., R_exp1 or R_exp2. At block 240, the random number associated with the site is then encrypted using the private key of server 110 and transmitted over the network at block 245. At block 250, server 110 awaits a response to the transmitted encrypted message.

When a response is received, a list of encryption algorithms available to each party is obtained at block 260. At block 265, server 110 acknowledges that a secure connection between the parties is established and an encryption algorithm is selected. Preferably, the encryption algorithm is present is present in at each party site. In another aspect, each party may provide a list of available encryption algorithms, from which server 110 may select comparable algorithms. In another aspect, server 110 may provide each party with a suitable encryption algorithm.

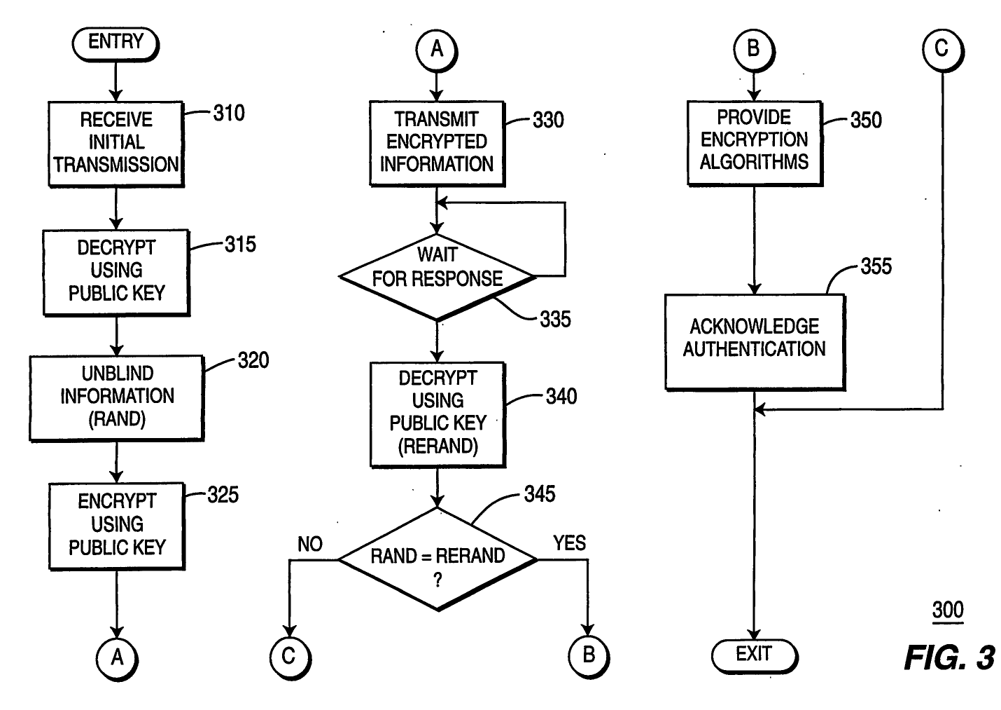

FIG. 3 illustrates a flow chart of a process 300 operable on a remote site for authenticating the parties and establishing a secure communication link between the parties. In this exemplary process, a remote site, e.g., site 130, receives an initial transmission from server 110 at block 310. At block 315, the message is decrypted using the public key of server 110. At block 320, the decrypted message is then unblinded using the unique identification code associated with each remote site. In the preferred embodiment of the invention, shown in equation [1], the information may be unblinded using the principle:
{[a XOR b] XOR b}=a [2]
where a is representative of the generated random number; and
   b is representative of the remote site identification value.

As would be recognized by those skilled in the art, only the remote site having knowledge of the associated identification value, code or label is able to correctly determine the generated random number.

At block 325, the unblinded random number is then encrypted using the public key of server 110 and transmitted over the network at block 330. At block 335, the remote site awaits a response from server 110.

When a response is received, the information is decrypted using the public key of server 110. At block 345, a determination is made whether the decrypted value from block 340 is the same as the decrypted, unblended value obtained at block 320. If the answer is negative, then processing ends, as there is a failure in the authorizations process.

However, if the answer is in the affirmative, then a list of encryption algorithms available to the remote site are provided to server 110 at block 350 and an acknowledgment that the authentication process is completed is provided at block 355.

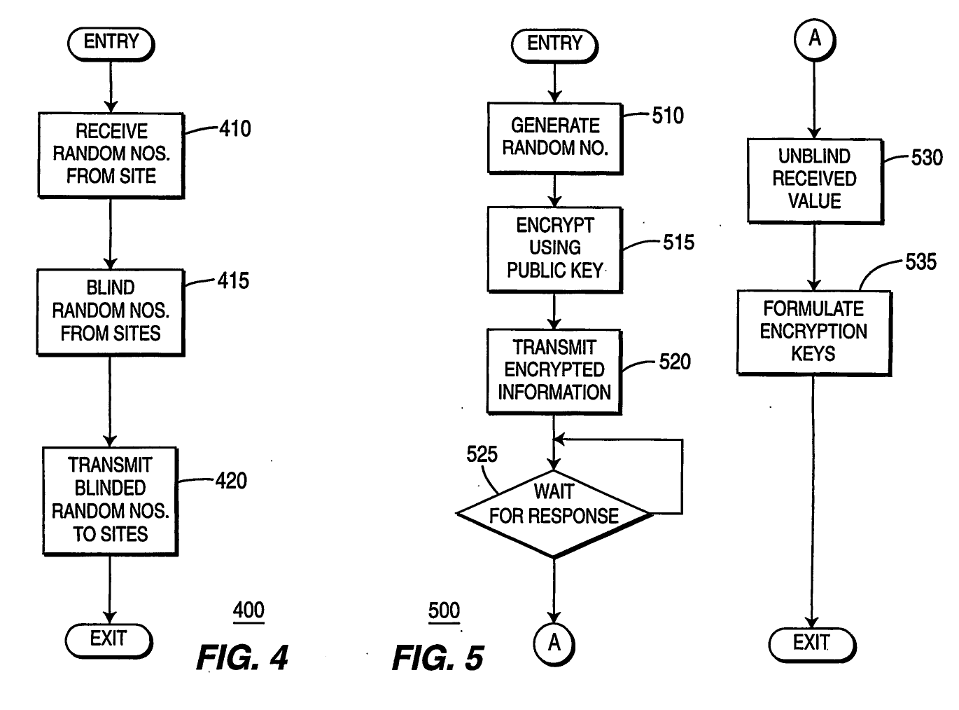

FIG. 4 illustrates a flow chart of an exemplary process 400 for admitting authenticated parties to a secure network configuration. In this illustrated process, at block 410, server 110 receives random numbers generated from each remote site capable of being authenticated, i.e., successfully complete the processing shown in FIGS. 2 and 3. The random numbers are arbitrarily generated. Preferably, there is no correlation between the random numbers generated. Although not shown, it would be appreciated that the random numbers may be received in an encrypted or scrambled form using a public key and may require decryption using a local key prior to subsequent usage.

At block 415, server 110 blinds the received random numbers using each of the unique remote site identification numbers. In one aspect of the invention, the random numbers are blinded using the logical function shown as:
R_site1XOR ID₂; and
R_site2XOR ID₁ [3]
where R_site1 is the random numbers generated by a first site;
   R_site2 is the random numbers generated by a second site;
   IDₐ is the unique value associated with a first site;
   ID_{b} is the unique value associated with a second site; and
   XOR is a conventional Boolean Logical function.

At block 420, the blinded values are then transmitted to the respective remote sites such that each remote site receives the blinded random number of another remote site.

In another, and preferred, aspect of the invention, the random numbers are blinded using the logical function shown as:
R_site1XOR R_site2 [4]

FIG. 5 illustrates a flow chart of an exemplary process 500 performed at each remote site for admitting authenticated parties to a secure network configuration. In this exemplary process, a random number is generated at block 510. At block 515, the generated random number is encrypted using server 110 public key and transmitted over the network at block 520. At block 525, the remote site waits for a response from server 110.

When a response is received, the received value is unblinded. In the aspect of the invention represented by equation 3, a process similar to that shown in equation 2 may be used to unblind the values. In the aspect of the invention represented by equation 4, the values may be unblinded in accordance with:
{[a XOR b] XOR b} [5]
where a is representative of a random value of one site; and
   b is representative of a random value of another site

Accordingly, each remote site possesses the random number generated by another remote site. At block 535, an encryption key is formulated using the random numbers generated by each site conforming to the selected encryption algorithm. Although not shown, it would be recognized by those skilled in the art, the blinded value received may further be encrypted using a private key. Hence, the received values are decrypted using a provided corresponding public key. As would be further understood, the order of processing blinding and encryption information may be interchanged without affecting the scope of the invention.

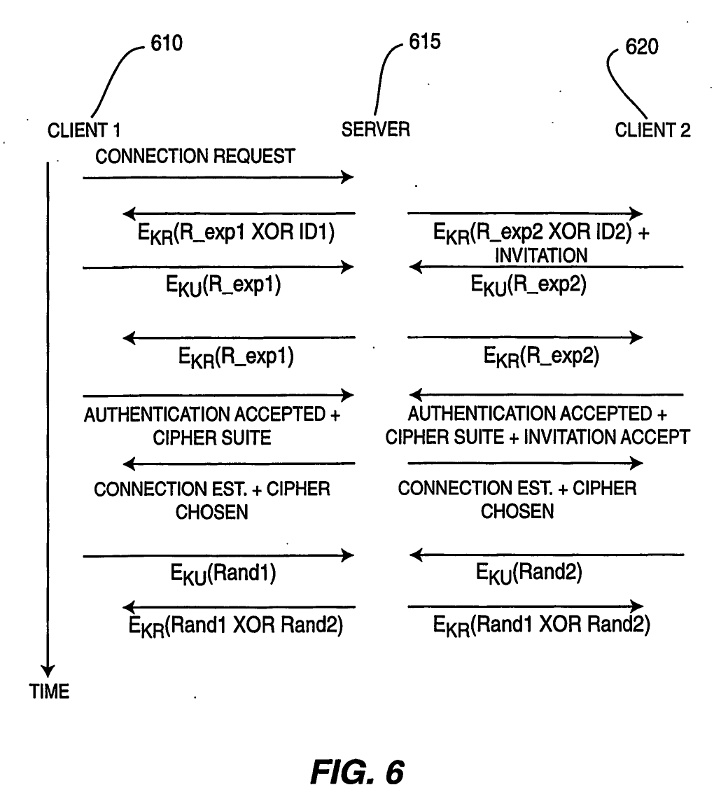

FIG. 6 depicts a chronological sequence 600 of the transfer of information between a party requesting a conference, referred to as client 1, 610, and server 615 and an invitee to the conference, referred to as client 2, 620. In this illustrated sequence, client 1, 610, sends a request, 630, for a conference with invitee 620 to server 615. Server 610 transmits to client 1, 610 and client 2, 620, encrypts blinded random values, R_exp1; i.e., Eₖᵣ(R_exp1 XOR ID1) and R_exp2, i.e., Eₖᵣ(R_exp2 XOR ID2), respectively.

Client 1, 610 and client 2, 620 transmit to server 615 encrypted values representative of R_exp1, i.e., Eₖᵤ(R_exp1), and R_exp2, i.e., Eₖᵤ(R_exp2), respectively. Server 620 then transmits to client 1, 610 and client 2, 620, digitally signed, encrypted random values R_exp1 and R_exp2, i.e., Eₖᵣ(R_exp1 ) and Eₖᵣ(R_exp2), respectively.

Client 1, 610 and client 2, 620, after successfully decrypting the transmitted values, then transmit and acknowledge a list of encryption algorithms, i.e., cipher suite, to server 615. Server 615 then provides an indication that a connection between the parties has been established and selects a cipher to secure the communications between the parties.

Client 1, 610 and client 2, 620 in one aspect of the invention may then generate random values, Rand1 and Rand2, respectively, and transmit encrypted versions of Rand1 and Rand 2 to server 615. Server 615 then transmits digitally signed blinded value, Eₖᵣ(Rand1 XOR Rand2) to both client 1, 610 and client 2, 620. Client 1, 610 and client 2, 620 may then use a known combination of Rand1 and Rand2 to form a session key suitable for the selected cipher.

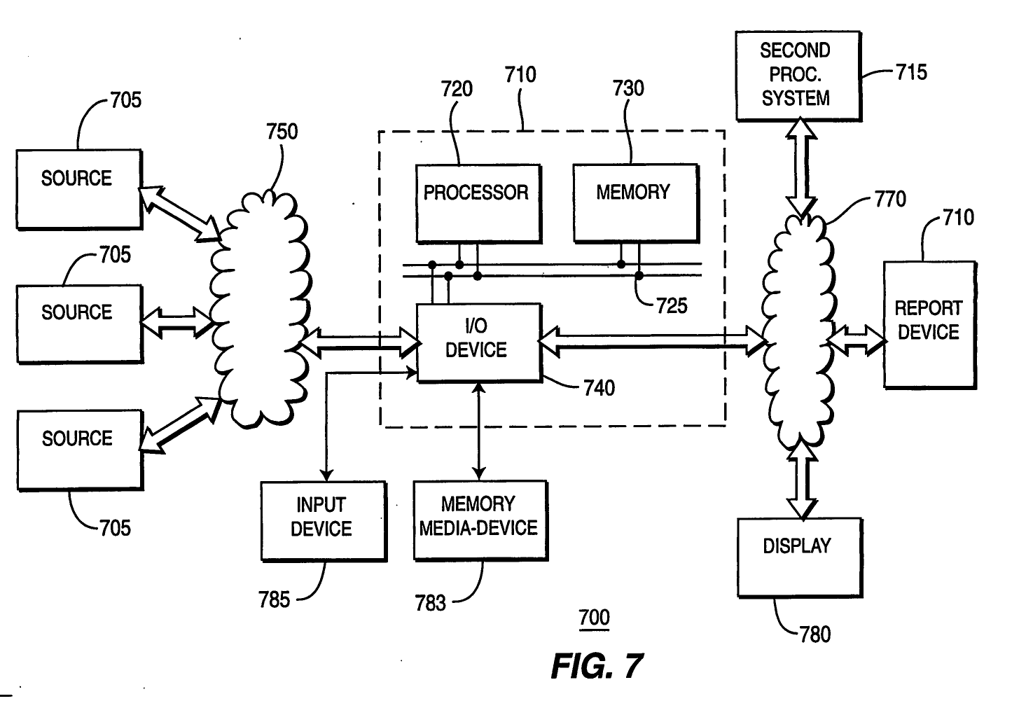

FIG. 7 illustrates a system 700 for implementing the principles of the invention as depicted in the exemplary processing shown in FIGS. 1 and 2. In this exemplary system embodiment 700, input data is received from sources 705 over network 750 and is processed in accordance with one or more software programs executed by processing system 710. Processor 710 may be representative of a handheld calculator, special purpose or general purpose processing system, desktop computer, laptop computer, palm computer, or personal digital assistant (PDA) device, etc., as well as portions or combinations of these and other devices that can perform the operations illustrated in FIGS. 1-6. The results of processing system 710 may then be transmitted over network 770 for viewing on display 780, reporting device 790 and/or a second processing system 795.

Specifically, processing system 710 includes one or more input/output devices 740 that receive data from the illustrated source devices 705 over network 750. The received data may then be applied to processor 720, which is in communication with input/output device 740 and memory 730. Processor 720 may be a central processing unit (CPU) or dedicated hardware/software, such as a PAL, ASIC, FGPA, operable to execute computer instruction code or a combination of code and logical operations. Input/output devices 740, processor 720 and memory 730 may communicate over a communication medium 725. Communication medium 725 may represent a communication network, e.g., ISA, PCI, PCMCIA bus, one or more internal connections of a circuit, circuit card or other device, as well as portions and combinations of these and other communication media.

In one embodiment, processor 720 may include code which, when executed, performs the operations illustrated herein. The code may be contained in memory 730, read or downloaded from a memory medium such as a CD-ROM or floppy disk represented as 783, or provided by manual input device 785, such as a keyboard or a keypad entry, or read from a magnetic or optical medium (not shown) which is accessible by processor 720, when needed. Information items provided by input device 783, 785 and/or magnetic medium may be accessible to processor 720 through input/output device 740, as shown. Further, the data received by input/output device 740 may be immediately accessible by processor 720 or may be stored in memory 730. Processor 720 may further provide the results of the processing shown herein to display 780, recording device 790 or a second processing unit 795 through I/O device 740.

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices illustrated may be electronically connected to the one or more processing units via internal busses, e.g., serial, parallel, ISA bus, microchannel bus, PCI bus, PCMCIA bus, USB, wireless, infrared, radio frequency, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

As would be understood, the operations illustrated in FIGS. 2-5 may be performed sequentially or in parallel using one or several different processors to determine specific values. Processor system 710 may also be in two-way communication with each of the sources 705. Processor system 710 may further receive or transmit data over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 750 and 770 may also be internal networks or one or more internal connections of a circuit, circuit card or other device, as well as portions and combinations of these and other communication media or an external network, e.g., the Internet and Intranet.

In a preferred embodiment of the invention, the selected encryption algorithm may be selected from the group consisting of stream cipher encryption or fast block cipher encryption algorithms. As would be recognized in the art, the specific algorithm selected may be determined based on the overall performance of the application and the network configuration. Furthermore, the size of a random value generated or the keys used in the encryption algorithm may be dependent upon the estimated length of the session. In another aspect of the invention, the duration of the encryption key may be selected dependent upon a maximum number of packets that may be transmitted. For example, the duration of the encryption key may be set for 10000 packets for a 1-hour session or 20000 packets for a 2-hour session. Thus, after a fixed amount of time or the transmission of a fixed number of packets the encryption key may be terminated and a new key established.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, although the present invention has been disclosed with regard to video conferencing, it would be recognized by those skilled in the art that the present invention may be used with audio and/or multimedia conferencing or exchange of data between parties. Although the present invention has been described with regard to a single set of keys, it is contemplated, and considered within the scope of the invention, that multiple sets of keys may be determined. For example, in a multimedia exchange one set on keys may be used for audio transmission and a second set of keys may be generated for video transmission. Furthermore, it would be recognized by those skilled in the art that the blinding operation may be performed by functions and/or operations similar to the XOR operation discussed.

It is expressly intended that all combinations of those elements that perform substantially the same function in substantially the same way to achieve the same results are within the scope of the invention. Substitutions of elements from one described embodiment to another are also fully intended and contemplated.

1. A system for authenticating and admitting parties located at remote sites to a secure communication network, wherein each remote site includes a device in communication with said network comprising:
a processor in communication with a memory, operable to execute code for:
determining a first authenticating value received over said network from a second one of said remote sites, wherein said first value is blinded by a value associated with said remote site;
encrypting said determined first authenticating value using an encryption key associated with said second one of said remote sites;
transmitting said encrypted first authenticating value over said network;
decrypting a second authenticating value received from said network, wherein said second value is decrypted using said encryption key; and
validating said second one of said remote sites when said first authenticating value is equivalent to said second authenticating value.

2. The system as recited in claim 1, wherein said processor is further operable to execute code for:
transmitting at least one indication associated with at least one encryption algorithm over said network.

3. The system as recited in claim 1, wherein said first authenticated value is encrypted.

4. The system as recited in claim 3, wherein said processor is further operable to execute code for:
decrypting said encrypted first authenticated value using said encryption key.

5. The system as recited in claim 1, wherein said processor is further operable to execute code for:
transmitting an encrypted admitting value over said network, wherein said admitting value is local to said remote site;
unblinding a second received value over said network; and
formulating a session encryption key using said admitting value and said unblinded second received value.

6. The system as recited in claim 5 wherein said second received value is encrypted.

7. The system as recited in claim 6, wherein said processor is further operable to execute code for:
decrypting said second received value.

8. The system as recited in claim 5, wherein said admitting value is a random value.

9. The system as recited in claim 1, wherein said encryption key is provided by said second one of said remote sites.

10. The system as recited in claim 9, wherein said encryption key is a public key associated with a public key/private key encryption algorithm.

11. The system as recited in claim 1, wherein said device further comprises:
an input/output unit operable to provide communication between said processor and said network.

12. The system as recited in claim 1, wherein code is stored in said memory.

13. The system as recited in claim 1, wherein said second one of said remote sites is not party to said secure communications.

14. The system as recited in claim 1, wherein said processor is operable to execute code for:
performing a logical operation to determine said a first authenticating value

15. A system for authenticating and admitting parties located at remote sites to a secure communication network, wherein a dedicated site not party to said secure communication network includes a device in communication with said network comprising:
a processor in communication with a memory, operable to execute code for:
transmitting an authenticating value blinded by a value associated with each of said remote sites over said network;
decrypting a value received over said network using an encryption key local to said dedicated site;
validating said remote site when said authenticating value is equivalent to said decrypted received value.

16. The system as recited in claim 15, wherein said processor is further operable to execute code for:
encrypting said blinded value using an encryption key local to said dedicated site.

17. The system as recited in claim 15, wherein said processor is further operable to execute code for: transmitting said authenticating value scrambled using an encryption key local to said dedicated site.

18. The system as recited in claim 15, wherein said processor is further operable to execute code for:
receiving an admitting value from an associated remote site; and
transmitting a blinded value associated with said received admitting values.

19. The system as recited claim 18, wherein said admitting value is encrypted using an encryption key available to said remote site.

20. The system as recited in claim 19, wherein said processor is further operable to execute code for:
decrypting said encrypted admitting value.

21. The system as recited in claim 18, wherein said blinded value is based on admitting values received from corresponding remote sites.

22. The system as recited in claim 18, wherein said blinded value is based on said admitting value and a remote site identification value.

23. The system as recited in claim 15, further comprising:
an input/output unit in communication with said processor and said network.

24. The system as recited in claim 15, wherein said code is stored in said memory.
